(19) United States
(12) Patent Application Publication
(10) Pub. No.: US 2002/0012192 A1
(43) Pub. Date: Jan. 31, 2002

(54) SYSTEM FOR RECORDING AND/OR REPRODUCING INFORMATION MEDIUM FOR USE IN THESYSTEM, AND MAGNETIC EMBOSS HEAD AND ARRANGEMENT FOR FORMATTING MEDIUM

(75) Inventors: ANTONIUS E .T. KUIPER, EINDHOVEN (NL); HANS W. VAN KESTEREN, EINDHOVEN (NL)

Correspondence Address: CORPORATE PATENT COUNSEL, US PHILIPS CORPORATION, 580 WHITE PLAINS ROAD, TARRYTOWN, NY, 10591

(73) Assignee: U.S. PHILLIPS CORPORATION

(21) Appl. No.: 09/216,267

(22) Filed: Dec. 18, 1998

(30) Foreign Application Priority Data
Dec. 22, 1997 (EP) 97204069.5

(51) Int. Cl. G11B 5/584

(52) U.S. Cl. 360/77.12

(57) ABSTRACT

The invention relates to a magnetic tape (10) formatted by means of a magnetic emboss head (60), and an apparatus comprising a magnetic data head (20) which is movable in a transverse direction (y) by means of an actuator (40). By means of the magnetic emboss head (60) the magnetic tape (10) has been provided with a pattern of servotracks ST1-ST17 which extend in a longitudinal direction (x). The odd-numbered servotracks contain a first servosignal and the even-numbered servotracks contain a second servosignal which is in phase opposition to the first servosignal. The servotracks ST2-ST8 and ST10-ST16 have a typical width W1 and form a group of two bands of seven servotracks which are separated by a band having a typical width D=(k+½)W1, where k=0, 1, 2 etc. The pattern of servotracks is suited to position a magnetic data head (20) of a first generation at four different positions and suited to position a magnetic data head (120) of a second generation at eight different positions by controlling the actuator in response to the servosignal (V1-V4) read by the data channels.

System for recording and/or reproducing information, medium for use in the system, and magnetic emboss head and arrangement for formatting the medium.

The invention relates to a system for recording and/or reproducing information, comprising

a) a magnetizable medium provided with a track pattern comprising

buried servotracks of a first type containing a first signal, and

buried servotracks of a second type containing a second signal, which servotracks extend substantially in a longitudinal direction and which track pattern, in a transverse direction perpendicular to the longitudinal direction, alternately comprises a servotrack of the first type followed by a servotrack of the second type, and b) an apparatus comprising

a magnetic data head comprising a plurality of data channels positioned at different positions in the transverse direction at a center-to-center distance p1,

means for moving the medium relative to the magnetic data head in the longitudinal direction,

an actuator for moving the magnetic data head relative to the medium in the transverse direction, and

a control unit for controlling the actuator, which control unit is adapted to generate a position signal based on the signals read by the data channels.

The invention also relates to a medium for such a system.

The invention further relates to a magnetic emboss head comprising a head face with a longitudinal direction in which a magnetizable medium is movable relative to the magnetic emboss head, and a transverse direction oriented transversely to the longitudinal direction, and further comprising a structure of integrated emboss channels, which structure terminates in the head face, which emboss channels are disposed adjacent one another in the transverse direction and extend substantially in the transverse direction.

The invention also relates to an arrangement comprising such a magnetic emboss head and means for scanning a magnetizable medium with the magnetic emboss head.

Such a medium, such a system and such a magnetic emboss head are known from WO 96/30897-A2. The known medium is a magnetic tape on which seven servotracks have been written by means of the known magnetic emboss head, the signal in the first servotrack being in phase with the signal in the third, the fifth and the seventh servotrack and the signals in the second, the fourth and the sixth servotrack being in phase opposition to the signals in the first, the third and the fifth servotrack. By means of an apparatus forming part of the known system it is possible to write information signals over the servotracks on the magnetic tape thus formatted. For this purpose, the apparatus comprises a magnetic data head having four data channels and means for moving the magnetic tape past the magnetic data head in a longitudinal direction. The known apparatus further comprises an actuator for positioning the magnetic data head in a transverse direction and a control unit for controlling the actuator. The control circuit comprises a comparator for generating a position signal based on the difference between the signal supplied by a first data channel and the signal supplied by a second data channel. The magnetic data head follows the servotracks on the magnetic tape on the basis of the position signal. A disadvantage of the known system, the known medium and the known magnetic emboss head is that after the whole magnetic tape has been written or read the magnetic tape is to be rewound in order to return it into its initial position. Another disadvantage of the known system is that the servotrack pattern is not suited for future generations with a double data track density.

It is an object of the invention to provide a system of the type defined in the opening paragraph, in which the medium is prepared for a future generation with a double track density. To this end, the system in accordance with the invention is characterized in that the track pattern comprises a group of at least two bands of a first type separated by a band of a second type, which bands of the first type adjoin a servotrack at their sides remote from the band of the second type,

the bands of the first type comprising at least one servotrack having a typical width W1, and

the band of the second type having a typical width D, which complies with

D=(k+½)W1

where k=0, 1, 2 etc. and the center-to-center distance p between the data channels complies with the relationship p=n.W1, where n=2, 4, 6, . . . etc.

By means of the measures in accordance with the invention it is achieved that the information can be read from and/or written on the servo track pattern in data tracks with a typical data track pitch T1=W1 and in data tracks with a typical data track pitch T2=½W1. This means that the data track density can be approximately equal and can be approximately twice as high as the servo track density. This means that the investments made for media can be used for two generations of data apparatuses. This makes the system very attractive for data back-up purposes in which a relatively large amount of money is invested in media.

The embodiment according to dependent claim 2 has the advantage that in each pass at least four data channels are positioned on a boundary of servotracks so that four data channels supply information about the position of the magnetic data head relative to the medium. Another four data channels will be positioned entirely on a servotrack so that these data channels can supply information on the speed of the medium relative to the magnetic data head. In this way a very robust system is obtained which is insensitive to local dropouts on the medium.

It is to be noted that the track pattern can be repeated several times in the transverse direction of the medium, as a result of which the magnetic data head can inscribe additional track patterns with information after a displacement in the transverse direction.

An embodiment of the system in accordance with the invention is characterized in that the medium has at least one servotrack having a width of at least n.W1. Owing to these measures one data channel can be disposed wholly on the n.W1 wide servotrack during all passes, thereby enabling this data channel to be used for reading the servo signal without the need to position the magnetic data head accurately in the transverse direction. This simplifies starting of the system in accordance with the invention.

The medium in accordance with the invention is characterized in that the track pattern comprises a group of at least two bands of a first type separated by a band of a second type, which bands of the first type adjoin a servotrack at their sides remote from the band of the second type,

the bands of the first type comprising at least one servotrack having a typical width W1, and

the band of the second type having a typical width D, which complies with

D=(k+1/2)W1

where k=0, 1, 2 etc.

The medium in accordance with the invention can be used in the system in accordance with the invention with the advantages outlined above.

Due to the measures of dependent claim 5, the magnetic emboss head for writing the servo pattern can be manufactured easily because the emboss channels do not have to be made smaller than W1. This is advantageous because smaller emboss channels are more difficult to produce. The dimensions of the emboss channels are also limited by the magnetic domain configuration of the material used for making flux guides in the emboss channel.

The embodiment according to dependent claim 6 has the advantage that the signals read from the servotracks in the band of the second type provide additional information about the position of the magnetic data head relative to the medium. This additional information makes it possible to determine quickly which data tracks are being accessed.

In a preferred embodiment the magnetic data head has eight data channels disposed at a center-to-center distance of 4 W1 and a recording width of approximately 1/2W1 or less. By means of such a magnetic data head it is possible to write 64 information tracks over this track pattern in eight passes. The choice for eight data channels results in a good balance between data rate (eight channels in parallel) and yield of the magnetic data head (more channels results in a lower yield).

In another embodiment the magnetic data head has at least sixteen data channels disposed at a center-to-center distance of 2W1 and a recording width of approximately 1/2W1 or less. By means of such a magnetic data head it is possible to write 64 information tracks in four passes. Since in this embodiment a large number of data channels are positioned on a boundary of servotracks a high degree of robustness is achieved. This enables a satisfactory tracking to be obtained even if a part of the servotracks is unreadable. Some of the data channels are always situated wholly on one servotrack, as a result of which these data channels can supply information about the phase of the servosignal and the speed of the medium relative to the magnetic data head. Another advantage of this embodiment is that each pass can be identified on the basis of the servosignals read by the data channels. This makes it possible to preclude that the servosystem, for example after having been subjected to an external mechanical shock, locks to another pass, where the apparatus continues writing.

An embodiment of the medium in accordance with the invention is characterized in that the first signal and the second signal each contain a fundamental and the first signal and the second signal are in phase opposition to one another. By means of the same frequency these measures it is achieved that the signal read by a data channel is zero if it is centered with respect to a boundary line between two servotracks. This is advantageous because, as a result of this, differences in sensitivity between the data channels have substantially no influence on the generation of the position signal and because a measurement signal which varies about zero makes it possible to implement a servosystem which is accurate and highly insensitive to offsets in the control unit.

The invention is particularly advantageous if the medium is a tape-like medium wound on a reel hub and accommodated in a housing of a cassette. With such a cassette the position of the medium relative to an apparatus with which the cassette cooperates is generally inaccurate because a tape-like medium is slack and this position is also determined by the housing of the cassette. In addition, the dimensions of a tape-like medium in the transverse direction can vary owing to expansion or contraction as a result of the absorption of moisture or release of moisture by the medium. The measures in accordance with the invention yet ensure an accurate position of the magnetic data head with respect to the medium, as a result of which high-density information storage is possible on the medium. Moreover, the medium in such a cassette is not fully protected against the ingress of dust and dirt from the environment and there is mechanical contact between the medium and the magnetic data head, which may give rise to scratches. As a result of dust, dirt or scratches some of the servosignals may be disturbed or completely unreadable at some locations. The measures in accordance with the invention mitigate the effect of dust, dirt and scratches on the tracking.

The magnetic emboss head and the arrangement in accordance with the invention are characterized in that

the structure comprises a group of at least two bands of a first type, which are separated by a band of a second type,

the bands of the first type adjoin an emboss channel at their sides remote from the band of the second type,

the bands of the first type have emboss channel having a typical width W1, and

the band of the second type has a typical width D, which complies with

D=(k+1/2)W1

where k=0, 1, 2 etc..

The invention will be now be described in more detail, by way of example, with reference to the drawings, in which

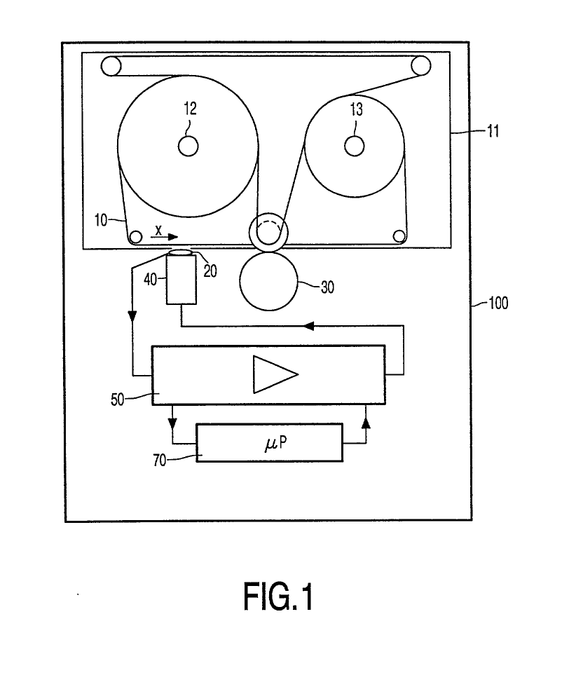

FIG. 1 shows diagrammatically the system in accordance with the invention,

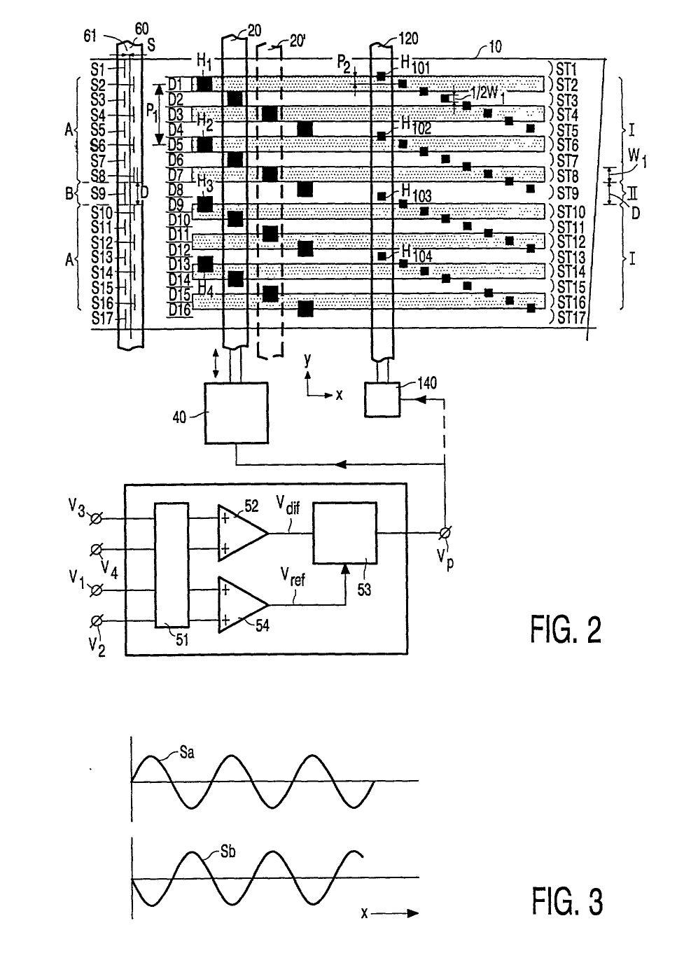

FIG. 2 shows a magnetic emboss head, a magnetic data head, an actuator and a first embodiment of the medium in accordance with the invention,

FIG. 3 shows two servosignals and their phase relationship to one another,

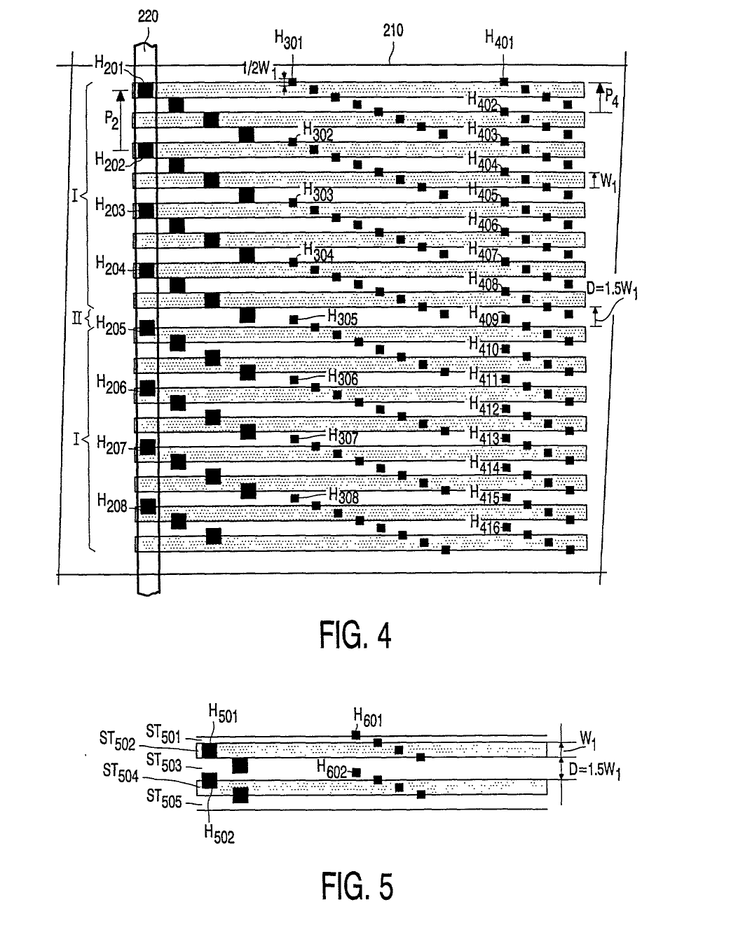

FIG. 4 shows diagrammatically a second embodiment of the medium in accordance with the invention,

FIG. 5 shows diagrammatically a third embodiment of the medium in accordance with the invention,

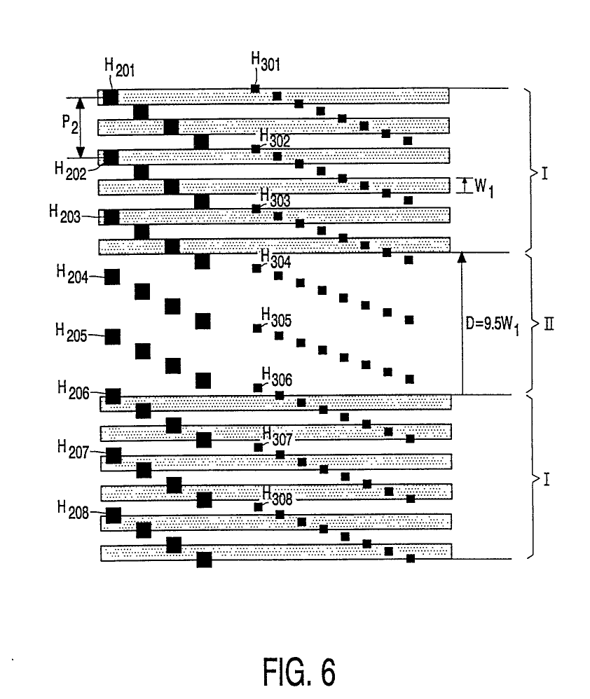

FIG. 6 shows diagrammatically a fourth embodiment of the medium in accordance with the invention,

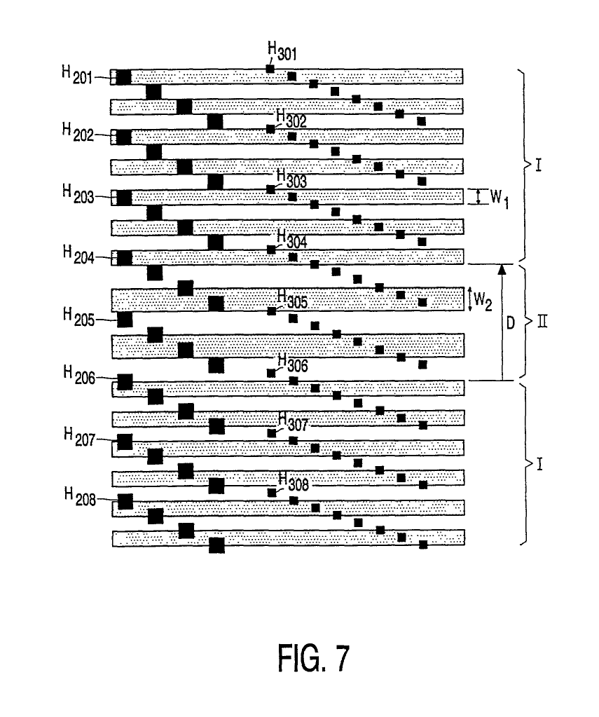

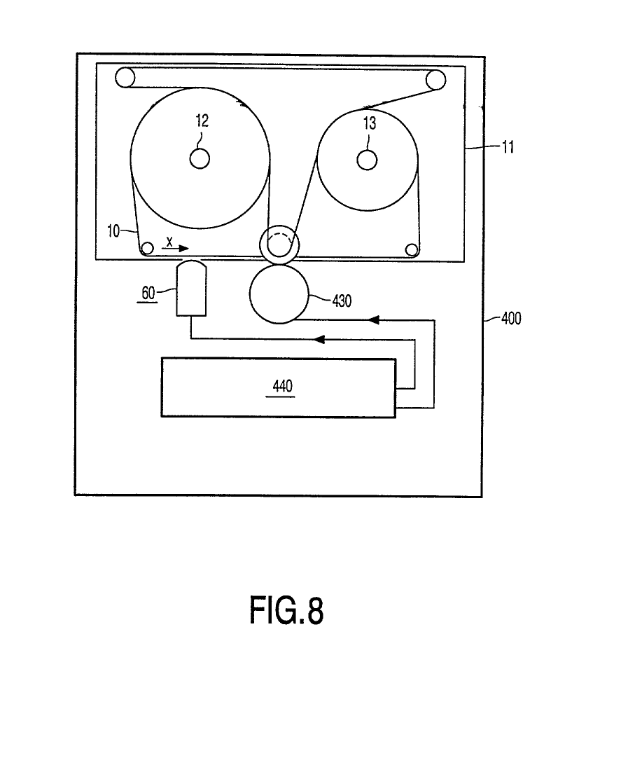

FIG. 7 shows diagrammatically a fifth embodiment of the medium in accordance with the invention, and

FIG. 8 shows diagrammatically an arrangement according to the invention.

FIG. 1 shows diagrammatically the system in accordance with the invention. The system includes an apparatus 100 and a magnetizable medium, in the present case a magnetic tape 10 accommodated in the housing of a cassette 11. The magnetic tape 10 has been provided with a pattern of servotracks in which servosignals are stored in the form of a magnetisation pattern recorded at a deep level (see FIG. 2). These deep servotracks are referred to as buried servotracks. The apparatus 100 comprises a magnetic data head 20 and means, in the present case a motor 30, for the relative movement of the magnetic tape 10 with respect to the magnetic data head 20 in a longitudinal direction x along the servotracks (see FIG. 2). The apparatus 100 further comprises an actuator 40, for moving the magnetic data head 20 transversely to the servotracks, and a servocircuit 50, arranged between the magnetic data head 20 and the actuator 40. The apparatus 100 comprises control means, in the present case a microcomputer 70, for controlling the actuator 40 and the magnetic data head 20.

FIG. 2 shows diagrammatically a magnetizable medium in the form of the magnetic tape 10, a magnetic emboss head 60, the magnetic data head 20 and the actuator 40. The magnetic tape 10 has been provided with a pattern of servotracks ST1-ST17 which extend in a longitudinal direction x and which adjoin one another in a transverse direction y which is perpendicular to the longitudinal x. The servotracks ST1, ST3, ST5 etc. are of a first type containing a servosignal Sa and the servotracks ST2 and ST4 are of a second type containing a servosignal Sb. The servosignals Sa and Sb each contain a fundamental of the same frequency but are in phase opposition to one another (see FIG. 3). The servosignals have been recorded by means of a magnetic emboss head 60 having a comparatively large gap length s. As a result of this, the servosignals are stored deep into the magnetic tape 10. The magnetic emboss head 60 has a head face 61 and a structure of integrated emboss channels S1-S17, which structure terminates in the head face 61, which emboss channels are disposed adjacent one another and extend substantially in the transverse direction. The structure comprises a group of two bands of a first type A with emboss channels S2-S8 and S10-S16, which are separated by a band of a second type B, in this case consisting of an emboss channel S9. The emboss channels S2-S8 and S10-S16 have a first typical width W1 and the emboss channel S9 has a second typical width D=1.5W1. By means of this magnetic emboss head 60 the track pattern ST1-ST17 is written onto the magnetic tape 10 in a single pass. This writing is preferably effected in an arrangement (see FIG. 8) specially designed for this purpose, when the magnetic tape is manufactured or when the magnetic tape 10 is loaded into the cassette 11.

The magnetic data head 20 forms part of the apparatus 100 as shown in FIG. 1 and comprises four data channels H1, H2, H3 and H4 capable of reading and writing simultaneously. The apparatus 100 as shown in FIG. 1 is adapted to write information signals in information tracks D1-D16. To this end, the magnetic data channels have a width of approximately W1. For positioning the magnetic data head 20 during writing and/or reading of the information tracks D1-D16 the apparatus 100 comprises an actuator 40 and a servocircuit 50. The servocircuit 50 is arranged between the magnetic data head 20 and the actuator 40 and is adapted to position the magnetic data head 20 with respect to the track pattern ST1-ST17 in response to the servosignals V1, V2, V3 and V4 read from the servotracks by the data channels H1, H2, H3 and H4, respectively. The servocircuit 50 comprises a selector 51 for selecting the signals received from data channels which are disposed on a boundary line between two servotracks and a first adder 52 for generating a signal Vdif from the selected signals. The selector 51 is controlled by the microcomputer 70 shown in FIG. 1. The servocircuit 50 further comprises a second adder 54 for generating a reference signal Vref obtained from the data channels which are disposed entirely on one of the servotracks. A multiplier 53 is employed to generate a position signal Vp by multiplying the signal Vdif and the reference signal Vref. The actuator 40 is driven until the position signal Vp is substantially equal to zero. For each pass of the magnetic data head 20, the reference signal Vref=V1+V2 and the signal Vdif=V3+V4 so that the selector is not operative in this embodiment.

The magnetic data head 120 shown in FIG. 2 is an example of a second generation embodiment in which the number of data tracks is doubled by halving the width of the magnetic data channels and adapting the generation of the position signal Vp. The magnetic data head 120 also forms part of an apparatus 100 as shown in FIG. 1 and also comprises four data channels H1, H2, H3 and H4 capable of reading and writing simultaneously. For positioning the magnetic data head 120 during writing and/or reading of information tracks the apparatus comprises an actuator 140 and the same servocircuit 50. In this second generation the servocircuit 50 is arranged between the magnetic data head 120 and the actuator 140 and is adapted to position the magnetic data head 120 with respect to the track pattern ST1-ST17 in response to the servosignals V1, V2, V3 and V4 in this second generation read from the servotracks by the data channels H101, H102, H103 and H104, respectively. In the second generation again the actuator 140 is driven until the position signal Vp is substantially equal to zero. For the subsequent passes of the magnetic data head 120, the reference signal Vref and the signal Vdif are generated as indicated below by appropriate control of the selector 51 by the microprocessor 70 (see FIG. 1).

| pass | Vref | Vdif |
|---|---|---|
| 1 | V3 + V4 | V1 + V2 |
| 2 | −(V1 + V2) | V3 + V4 |
| 3 | V3 + V4 | V1 + V2 |
| 4 | V1 + V2 | −(V3 + V4) |
| 5 | V3 + V4 | V1 + V2 |
| 6 | −(V1 + V2) | V3 + V4 |
| 7 | V3 + V4 | V1 + V2 |
| 8 | V1 + V2 | −(V3 + V4) |

The center-to-center distance p1 between the magnetic data channels H101-H104 is also equal to four times the typical width W1 of the servotracks ST2-ST8 and the width of the data channels is approximately ½W1. As a result, eighth passes are needed to provide the magnetic tape 10 wholly with 32 information tracks. After these passes the magnetic tape 10 has resumed its initial position.

FIG. 4 shows diagrammatically a second embodiment of the medium in accordance with the invention. The magnetic tape 210 has been provided with a pattern of servotracks which extend in a longitudinal direction. The non-shaded servotracks contain a servosignal Sa and the shaded servotracks contain a servosignal Sb. The servosignals Sa and Sb each contain a fundamental of the same frequency but are in phase opposition to one another (see FIG. 3). The servosignals have been recorded by means of a magnetic emboss head, not shown, as described with reference to FIG. 2. The magnetic tape 210 is adapted to co-operate with an apparatus comprising a magnetic data head 220 having eight data channels H201-H208. The center-to-center distance p2 between the magnetic data channels H201-H208 is equal to four times the typical width W1. As a result four passes are needed to provide the whole magnetic tape 210 with 32 information tracks in a manner comparable to that described with reference to FIG. 2. After these four passes the magnetic tape 210 has again reached its initial position.

The magnetic tape 210 is also suited to cooperate with a second generation apparatus comprising a magnetic data head having eight data channels H301-H308 with a center-to-center distance p2 and a width of approximately ½W1. Eight passes are needed to provide the whole magnetic tape 210 with 64 information tracks in a manner comparable to that described with reference to FIG. 2. After these eight passes the magnetic tape 210 has again reached its initial position.

The magnetic tape 210 is also suited to cooperate with a second generation apparatus comprising a magnetic data head having sixteen data channels H401-H416 with a center-to-center distance p4=2.W1 and a width of approximately ½W1. Four passes are needed to provide the whole magnetic tape 210 with 64 information tracks in a manner comparable to that described with reference to FIG. 2.

FIG. 5 shows diagrammatically a part of third embodiment of the medium in accordance with the invention. The medium comprises a group of servotracks ST501-ST505 which extend in a longitudinal direction. The odd-numbered servotracks contain a servosignal Sa and the even-numbered servotracks contain a servosignal Sb. The servosignals Sa and Sb each contain a fundamental of the same frequency but are in phase opposition to one another (see FIG. 3). The servosignals have been recorded by means of a magnetic emboss head, not shown, as described with reference to FIG. 2. The servotracks ST502 and ST504 have a typical width W1 and are separated by the servotracks ST503 having a typical width of D=1.5W1. The magnetic tape is adapted to cooperate with an apparatus comprising magnetic data channels H501 and H502. As a result, two passes are needed to provide the shown pattern with four information tracks in a manner comparable to that described with reference to FIG. 2.

The magnetic tape is also suited to cooperate with an apparatus comprising magnetic data channels H601 and H602. With such an apparatus, four passes are needed to provide the shown pattern with eighth information tracks in a manner comparable to that described with reference to FIG. 2. This group of servotracks can be repeated many times on a magnetic tape so that a large number of parallel servotracks is obtained over which data tracks it is possible to write with single and double track density.

FIG. 6 shows diagrammatically a part of a fourth embodiment of the medium in accordance with the invention and magnetic data channels H201-H208 and H301-H308. This embodiment differs from that shown in FIG. 4 in that the bands of the first type I are separated by a band of second type II which consists of a single servotracks with a width D=9.5 W1 and which comprises a periodic servosignal Sb (see FIG. 3). As this servotrack is wider than twice the center-to-center distance between the magnetic data channels, there are in each pass at least two data channels, i.e. H204 and H205 or H304 and H305, which read the signal from this servotrack without interference of neighbouring tracks. As this signal is periodic it can be used, for example, as a speed signal representative of the speed of the magnetic data head relative to the medium.

FIG. 7 shows diagrammatically a part of a fifth embodiment of the medium in accordance with the invention and magnetic data channels H201-H208 and H301-H308. This embodiment differs from that shown in FIG. 4 in that the bands of the first type I are separated by a band of second type II which consists of five servotracks with a width W₂=1.5 W1. With this fifth embodiment each of the four passes of the data channels H201-H208 can be identified on basis of the signals read by the data channels because the relation between the signals differs per pass.

FIG. 8 shows an embodiment of the arrangement according to the invention. The arrangement 400 comprises a space for accommodating a cassette 11. The cassette 11 has two reel hubs 12 and 13 on which a magnetic tape (10) is wound. The arrangement 400 further comprises a magnetic emboss head 60 and a motor 430 for moving the magnetic tape 10 past the magnetic emboss head 60 so that the tape 10 can be scanned. The arrangement 100 further comprises control electronics 440 for driving the magnetic emboss head 60 and the motor 430. With this arrangement a magnetic tape 10 can be provided with servotracks as explained with reference to FIG. 2.

It is to be noted that the invention is not limited to the embodiments disclosed herein. Various other embodiments are possible within the scope of the invention. It is possible, for example, to use a magnetic disc instead of a magnetic tape. Besides, the servosignals Sa and Sb can be signals of different frequency, the servo circuit generating a position signal for controlling the actuator in dependence on the amplitude of the servosignals Sa and Sb as read by a number of data channels.

1. A system for recording and/or reproducing information, comprising a) a magnetizable medium (10) provided with a track pattern comprising
buried servotracks of a first type (ST2, ST4 etc.) containing a first signal (Sa), and
buried servotracks of a second type (ST3) containing a second signal (Sb), which servotracks extend substantially in a longitudinal direction (x) and which track pattern, in a transverse direction perpendicular (y) to the longitudinal direction, alternately comprises a servotrack of the first type followed by a servotrack of the second type, and b) an apparatus (100) comprising
a magnetic data head (20) comprising a plurality of data channels (H1, H2, H3, H4) positioned at different positions in the transverse direction (y) at a center-to-center distance p1,
means (30) for moving the medium relative to the magnetic data head in the longitudinal direction (x),
an actuator (40) for moving the magnetic data head relative to the medium in the transverse direction (y), and
a control unit (50) for controlling the actuator, which control unit is adapted to generate a position signal (Vp) based on the signals read by the data channels (H3, H4), characterized in that the track pattern comprises a group of at least two bands of a first type (I) separated by a band of a second type (II), which bands of the first type adjoin a servotrack (ST1, ST17) at their sides remote from the band of the second type,
the bands of the first type comprising at least one servotrack (ST2-ST8) having a typical width W1 and
the band of the second type having a typical width D, which complies with
D=(k+½)W1
where k=0, 1, 2 etc. and the center-to-center distance p between the data channels complies with the relationship p=n.W1, where n=2, 4, 6, . . . etc.

2. A system as claimed in claim 1, characterized in that the bands of the first type comprise at least fifteen servotracks and the magnetic data head (220) comprises at least eighth magnetic data channels (H201-H208) positioned at a center-to-center distance of 4W1.

3. A system, as claimed in claim 1, characterized in that the medium (110; 310) has at least one servotrack (ST11, ST101) having a width of at least n.W1.

4. A magnetizable medium (10) provided with a track pattern comprising
buried servotracks of a first type (ST2, ST4 etc.) containing a first signal (Sa), and
buried servotracks of a second type (ST3) containing a second signal (Sb), which servotracks extend substantially in a longitudinal direction (x) and which track pattern, in a transverse direction perpendicular (y) to the longitudinal direction, alternately comprises a servotrack of the first type followed by a servotrack of the second type, characterized in that the track pattern comprises a group of at least two bands of a first type (I) separated by a band of a second type (II), which bands of the first type adjoin a servotrack (ST1, ST17) at their sides remote from the band of the second type,
the bands of the first type comprising at least one servotrack (ST2-ST8) having a typical width W1, and
the band of the second type having a typical width D, which complies with
D=(k+½)W1 where k=0, 1, 2 etc.

5. A magnetizable medium (10) as claimed in claim 4, characterized in that the band of the second type has a typical width D=1.5 W1 and comprises a single servotrack.

6. A magnetizable medium (210) as claimed in claim 4, characterized in that the band of the second type comprises N2 servotracks with a typical width W2, and
W2=(m+½)W1 where m=0, 1, 2 etc. and N2=1, 3, 5, etc.

7. A magnetizable medium (10; 110; 210; 310) as claimed in any one of the preceding claims 4 to 6, characterized in that the first signal (Sa) and the second signal (Sb) each contain a fundamental of the same frequency and the first signal and the second signal are in phase opposition to one another.

8. A cassette (11) having a housing which accommodates at least one reel hub (12, 13) onto which a tape-like magnetizable medium (12) has been wound, which medium is a medium as claimed in any one of the preceding claims 3 to 8.

9. A magnetic emboss head (60) comprising a head face (61) with a longitudinal direction (x) in which a magnetizable medium (10) is movable relative to the magnetic emboss head, and a transverse direction (y) oriented transversely to the longitudinal direction (x), and further comprising a structure of integrated emboss channels (S1-S17), which structure terminates in the head face, which emboss channels are disposed adjacent one another in the transverse direction (y) and extend substantially in the transverse direction, characterized in that
the structure comprises a group of at least two bands of a first type (A), which are separated by a band of a second type (B),
the bands of the first type adjoin an emboss channel (S1, S17) at their sides remote from the band of the second type,
the bands of the first type have emboss channel having a typical width W1, and
the band of the second type has a typical width D, which complies with
D=(k+½)W1 where k=0, 1, 2 etc..

10. An arrangement comprising a magnetic emboss head (60) and means (30) for scanning a magnetizable medium (10) by means of the magnetic emboss head, the magnetic emboss head (60) comprising a head face (61) with a longitudinal direction (x) in which a magnetizable medium (10) is movable relative to the magnetic emboss head, and a transverse direction (y) oriented transversely to the longitudinal direction (x), and further comprising a structure of integrated emboss channels (S1-S17), which structure terminates in the head face, which emboss channels are disposed adjacent one another in the transverse direction (y) and extend substantially in the transverse direction, characterised in that
the structure comprises a group of at least two bands of a first type (A), which are separated by a band of a second type (B),
the bands of the first type adjoin an emboss channel (S1, S17) at their sides remote from the band of the second type,
the bands of the first type have emboss channel having a typical width W1 and
the band of the second type has a typical width D, which complies with
D=(k+1/2)W1 where k=0, 1, 2 etc..
